(19) United States
(12) Patent Application Publication
(10) Pub. No.: US 2015/0073885 A1
(43) Pub. Date: Mar. 12, 2015

(54) Mobile Coupon Application Network

(71) Applicant: Mehrdad Feiz-Ekbatani, Irvine, CA (US)

(72) Inventor: Mehrdad Feiz-Ekbatani, Irvine, CA (US)

(73) Assignee: COUPZILLA, INC., Irvine, CA (US)

(21) Appl. No.: 14/481,734

(22) Filed: Sep. 9, 2014

Related U.S. Application Data
(60) Provisional application No. 61/876,117, filed on Sep. 10, 2013.

(51) Int. Cl. G06Q 30/02

(52) U.S. Cl. CPC G06Q 30/0261; G06Q 30/0269; G06Q 30/0211
USPC 705/14.13; 705/14.58

(57) ABSTRACT

A mobile coupon application network operates between a plurality of merchant profiles and a user account. The plurality of merchant profiles and the user account are stored within a remote server along with a plurality of coupons that is uploaded by the each of the plurality of merchant profiles. The user account is able to access the plurality of coupons through a portable computing device as the portable computing device communicates with the remote server. The plurality of coupons provides location-based coupons and non-location-based coupons so that the user account is able to select a desired coupon from a variety of coupon categories. Once the desired coupon is selected by the user account, the remote server executes a redeeming process for the desired coupon calculating a discounted retail price for the purchasing product.

The current application claims a priority to the U.S. Provisional Patent application Ser. No. 61/876,117 filed on Sep. 10, 2013.

### FIELD OF THE INVENTION

The present invention relates generally to a method of user interaction with a mobile coupon application network. More specifically, the present invention provides a plurality of redeemable coupons to the user account while allowing the merchants to control the marketing, promotional, and discounts aspect of their respective businesses.

### BACKGROUND OF THE INVENTION

One of the main features of online marketing is the implementation of coupons, where the coupons are generally presented as the paper coupons and/or digital coupons. Coupon is generally exchanged for a financial discount or rebate during a product purchasing process. With the advent of mobile technology, people have become more dependent mobile coupon applications as they provide an efficient method to the usage of the digital coupons. Even though many different mobile coupon applications are available for consumers, none of these mobile coupon applications are able to effectively and efficiently connect different merchants together.

It is an object of the present invention to introduce a method of user interaction with a mobile coupon application network so that the user and the different merchants are able to efficiently communicate with each other. More specifically, the merchants upload and control the different type of coupons in relations to their businesses. At the same time, the user is able to view and use those coupons upon his or her discretion. The different type of coupons of the present invention can be location-based coupons, non- location-based coupons, and reward coupons as each of them provides a different financial discount to the user.

### BRIEF DESCRIPTION OF THE DRAWINGS

FIG. 1 is a flow chart illustrating the basic overall method of the present invention.

FIG. 2 is a flow chart illustrating the creation of the merchant profile within the overall method of the present invention.

FIG. 3 is a flow chart illustrating the receiving of the desired location within the overall method of the present invention.

FIG. 4 is a flow chart illustrating the selection of the location-based coupon within the overall method of the present invention.

FIG. 5 is a flow chart illustrating the selection of the non-location-based coupon within the overall method of the present invention.

FIG. 6 is a flow chart illustrating the redeeming process within the overall method of the present invention.

FIG. 7 is a flow chart illustrating the functionalities for the list of redeemed coupon list within the overall method of the present invention.

FIG. 8 is a diagram illustrating the notification region, the synthetic region, and the expanded notification region of the present invention in relation to the user account.

FIG. 9 is a diagram illustrating the movement of the user account from position A to position C in relation to the notification regions and the synthetic regions.

### DETAIL DESCRIPTIONS OF THE INVENTION

All illustrations of the drawings are for the purpose of describing selected versions of the present invention and are not intended to limit the scope of the present invention.

The present invention is a method for operating a mobile coupon application network between a plurality of merchant profiles and a user account. Even though the present invention is explained in relation to the user account, the present invention utilizes the same exact process for multiple user accounts. The present invention, which is the method for operating the mobile coupon application, is implemented by a remote sever. Each of the plurality of merchant profiles includes a plurality of coupons, at least one promotional announcement, and a notification region. The user account is accessed through a portable computing device so that the user account is able to access the plurality of merchant profiles of the present invention. In order to access the present invention, the plurality of merchant profiles needs to be created and stored within the remote server and the user account has to be registered within the remote server by the respective users.

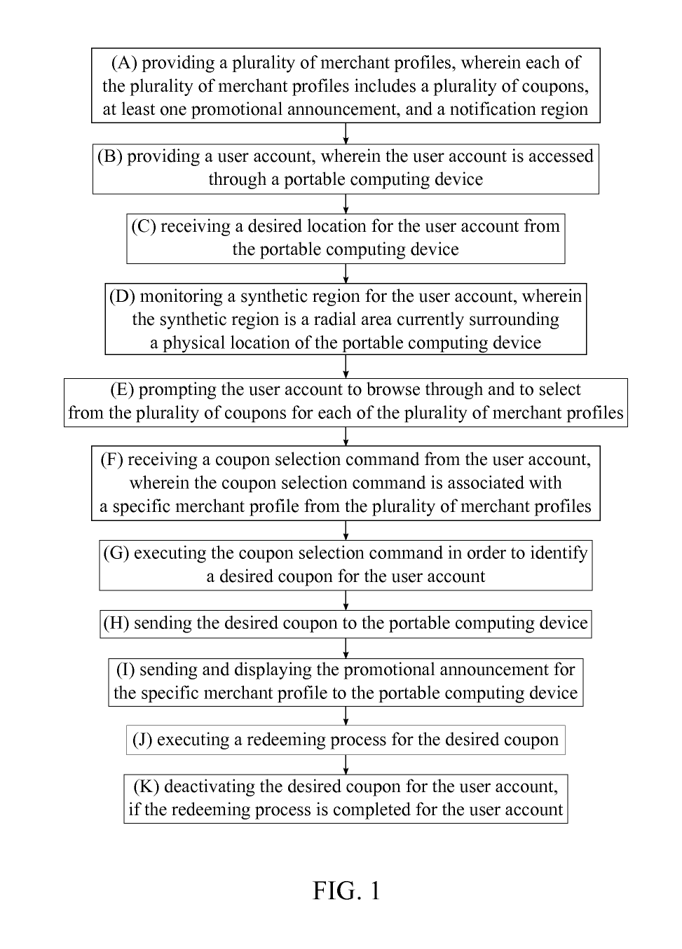

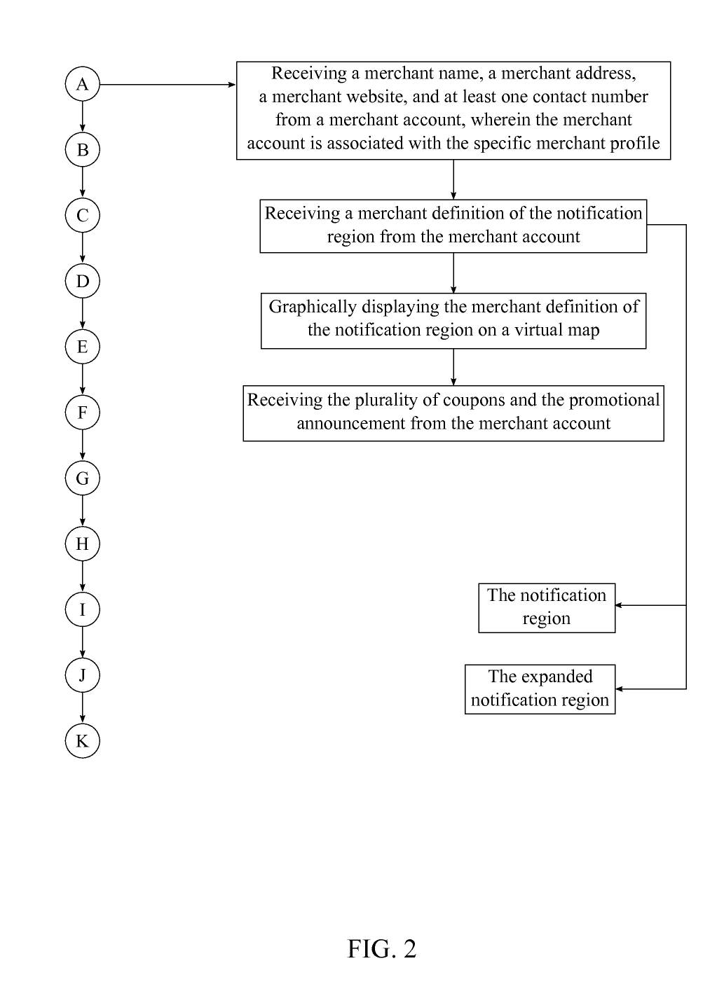

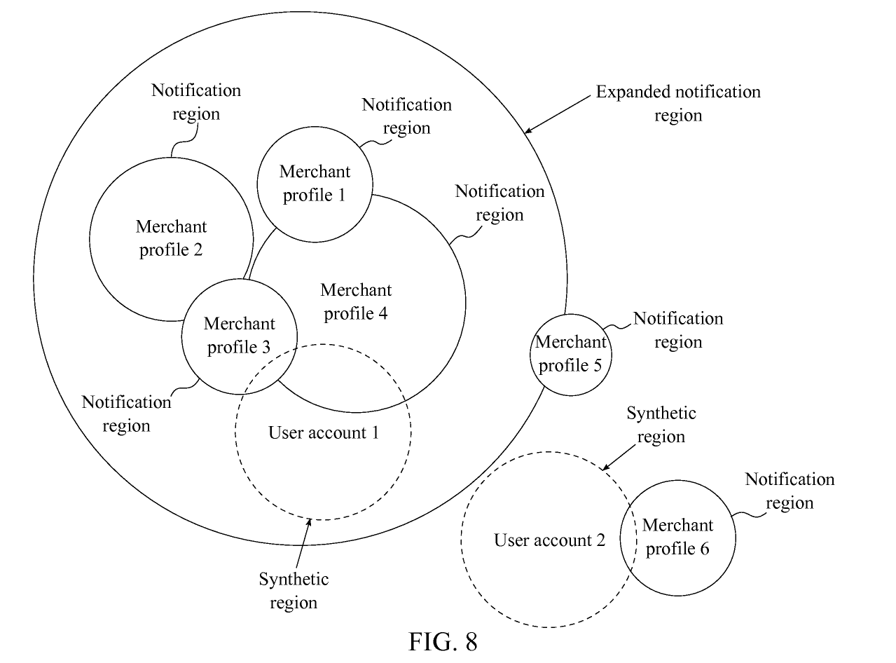

In order to create a specific merchant profile from the plurality of merchant profiles, a merchant account that is associated with the specific merchant profile needs to enter a merchant name, a merchant address, a merchant website, and at least one contact number to the remote server through the present invention as shown in FIG. 1 and FIG. 2. Once the remote server receives the merchant name, the merchant address, the merchant website, and the at least one contact number, the present invention is able to create the specific merchant profile and stored within the remote server. Then a merchant definition of the notification region is received from the merchant account so that the notification region can be defined upon the merchant account discretion. After the notification region is defined, the present invention prompts the merchant account to advertise the notification region by itself around the merchant address of the specific merchant profile or as a sub entity of an expanded notification region. In reference to FIG. 8, if the merchant account decides to advertise the notification region by itself, the notification region provides a radial parameter around the merchant address of the specific merchant profile. However, if the merchant account desires, the merchant account can advertise the notification region within the expanded notification region. As shown in FIG. 8 the expanded notification region, the present invention prompts the merchant account to group the specific merchant profile with proximal merchant profiles from the plurality of merchant profiles, wherein the proximal merchant profiles and the specific merchant profile share the same physical address in addition the merchant addresses of the proximal merchant profiles and the specific merchant profile. Then the present invention generates the expanded notification region for the specific merchant profile and the proximal merchant profiles in such a way that the expanded notification region is a combination of the notification region for the specific merchant profile and the notification region for each of the proximal merchant profiles. For example, the expanded notification region of the present invention can be a shopping mall while the notification region for the specific merchant profile and the notification region for each of the proximal merchant profiles represent the individual stores of the shopping mall.

Once the notification region is defined according to the merchant definition and stored within the remote server, the present invention is able to graphically display the merchant definition of the notification region on a virtual map. In other words, the merchant account is able to control and define the notification region of the specific merchant profile. Then the present invention prompts the merchant account to upload the plurality of coupons and the promotional announcement for the specific merchant profile.

Once the merchant account uploads the plurality of coupons and/or the promotional announcement, the present invention receives the plurality of coupons and/or the promotional announcement and stores within the remote server. During the coupon uploading process, the merchant account is able to assign each of the plurality of coupons into different categories. More specifically, the plurality of coupons for each of the plurality of merchant profiles includes at least one location-based coupon and at least one non-location-based coupon that can further include featured coupons and broadcast coupons. The different categories of the plurality of coupons provide different levels of interaction between the merchant profiles and the user account.

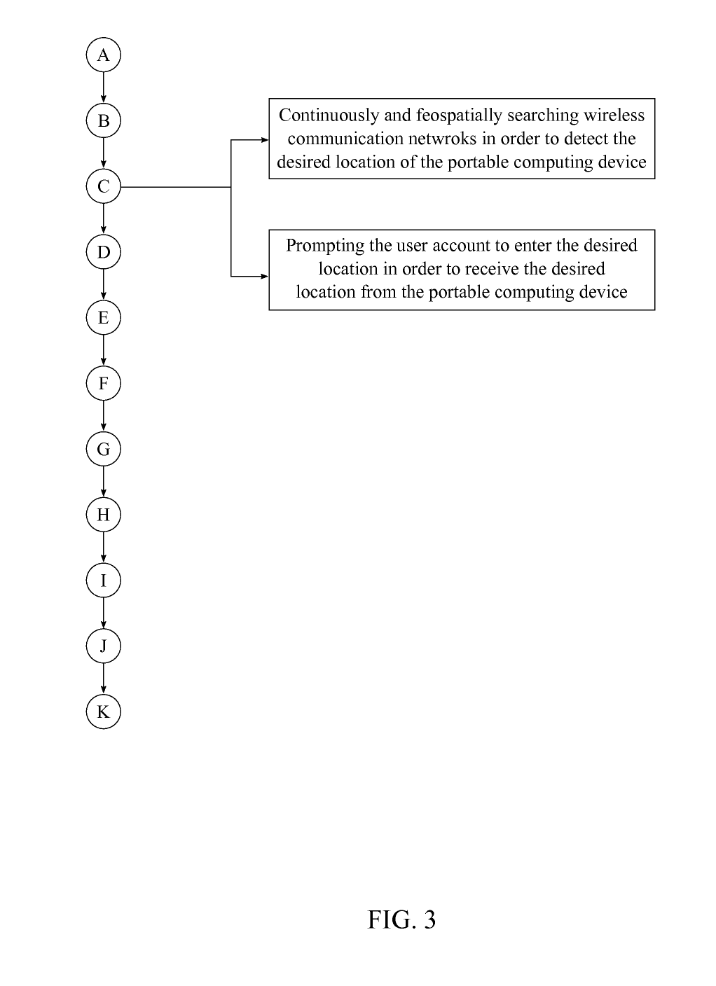

The present invention creates the user account by utilizing a general sign-up process and stores within the remote server; however a guess account of the present invention can also identify as the user account. Since the user account is accessed through the portable computing device, the present invention is able to locate a desired location for the user account from the portable computing device. More specifically, the remote server is able to receive the desired location of the portable computing device by utilizing two different methods, where one does not precede the other. As for the first method that is shown in FIG. 3, the present invention continuously and geospatially searches wireless communication networks in order to detect the desired location of the portable computing device. The present invention is able to utilize a global positioning system (GPS), a wireless router network system, a mobile network system, or any other types of communicating systems so that the present invention is able to recognize the portable computing device and retrieves the desired location of the user account. As for the second method that is shown in FIG. 3, the present invention prompts the user account to enter the desired location from the portable computing device so that the present invention is able to retrieve the desired location directly from the user account.

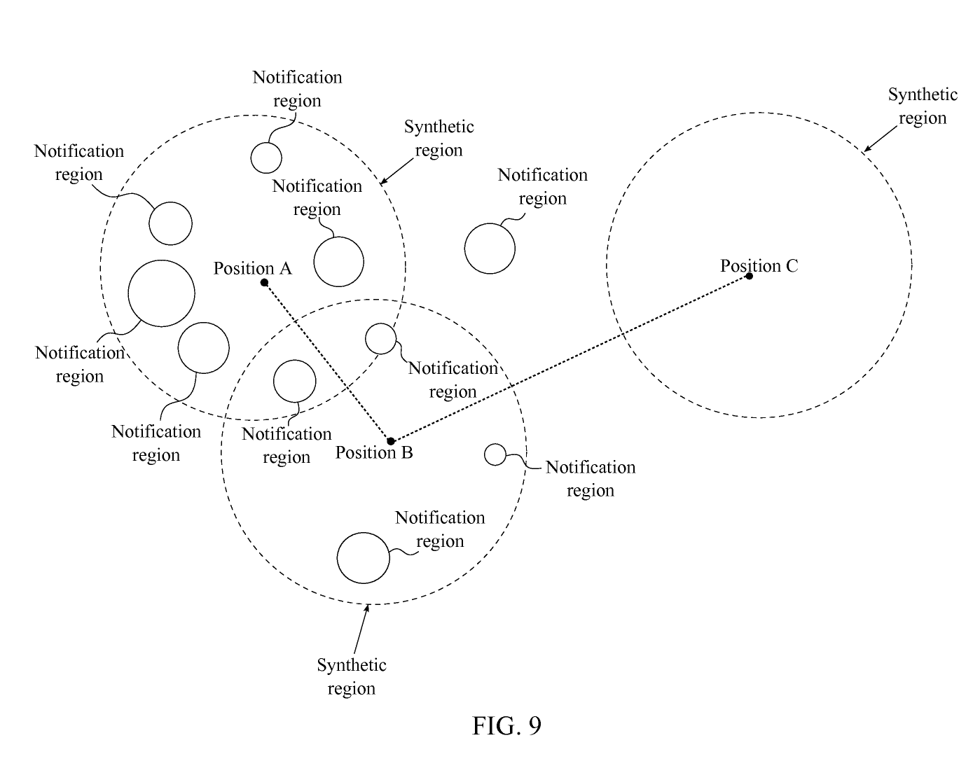

In reference to FIG. 1, the present invention monitors a synthetic region for the user account, where the synthetic region is a radial area currently surrounding a physical location of the portable computing device so that the present invention can enhance the precision identifying of the portable computing device. More specifically, the synthetic region can be predefined radius or a radius of representing 90% of the distance to the farthest merchant profile from the plurality of merchant profiles. When the portable computing device moves along a path, the monitoring process of the synthetic region restarts by clearing already monitored regions, identifying the closest 19 merchant profiles to the new location, and generating a new synthetic region centered around the current location with a radius representing 90% of the distance to the farthest merchant profile. This process can repeat indefinitely, even if the portable computing device is not actively accessing the present invention. For example, as shown in FIG. 9, the portable computing device respectively moves from position A, to position B, and to position C. When the portable computing device is at the initial position, which is the position A, the present invention creates the synthetic region A that contains most of the nearby merchant profiles. When the portable computing device moves outside the synthetic region A and into the position B, the present invention creates the new synthetic region B that is centered on the current location of the portable computing device. When the portable computing device moves outside the bounds of the synthetic region A and B and into the position C, the new synthetic region C would be created. The monitoring of the synthetic region, handling of the monitored regions, representing of the farthest merchant profile, and the closest 19 merchant profiles can happen even when the present invention is not actively accessed, is in the background or has been forcibly closed by the user account.

In reference to FIG. 1, once the present invention receives the desired location for the user account, the present invention prompts the user account to browse through and select from the plurality of coupons for each of the plurality of merchant profiles. Since the plurality of coupons includes the at least one location-based coupon and the at least one non-location-based coupon that further includes the featured coupons and the broadcast coupons, the present invention allows the user account to browse through all of these categories of the plurality of coupons.

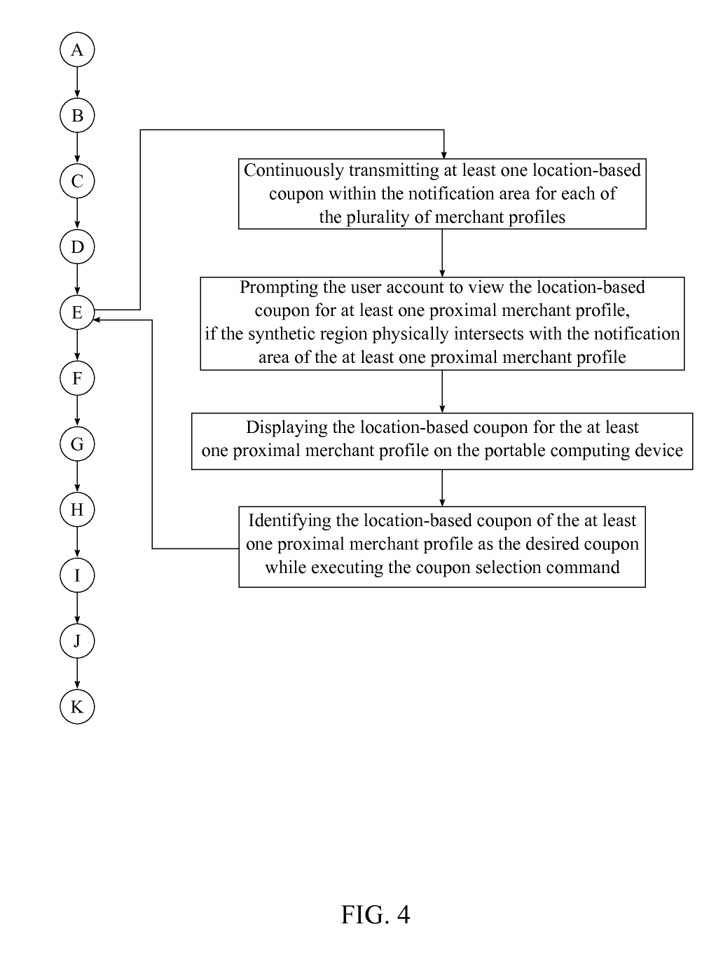

In reference to FIG. 4, the present invention continuously transmits the location-based coupon within the notification area for each of the plurality of merchant profiles so that the present invention is able to prompt the user account view the location-based coupon for at least one proximal merchant profile if the synthetic region physically intersects with the notification area of the at least one proximal merchant profile. Then the present invention displays the location-based coupon for the at least one proximal merchant profile on the portable computing device so that the user account is able to view the location-based coupon.

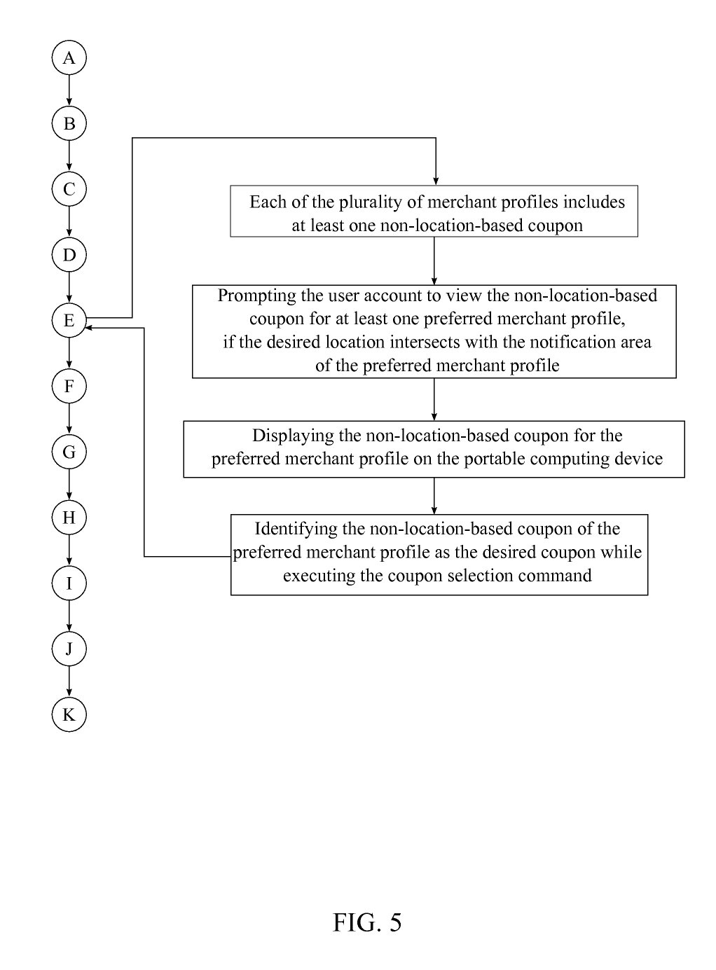

In reference to FIG. 5, the present invention continuously transmits the non-location-based coupon to the user account so that the present invention is able to prompt the user account view the non-location-based coupon for at least one preferred merchant profile if the desired location intersects with the notification area of the preferred merchant profile. Then the present invention displays the non-location-based coupon for the preferred merchant profile on the portable computing device so that the user account is able to view the non-location-based coupon. Furthermore, the non-location-based coupon displays the featured coupons and the broadcast coupons providing variety of different options for the user account.

After the plurality of coupons is displayed to the user account, the present invention prompts the user account to provide a coupon selection command. Then the present invention receives the coupon selection command from the user account, wherein the coupon selection command is associated with the specific merchant profile. Then the present invention executes the coupon selection command in order to identify a desired coupon for the user account. More specifically, the present invention identifies the non-location-based coupon of the preferred merchant profile as the desired coupon while executing the coupon selection command, if the user account selects the non-location-based coupon. Then the preferred merchant profile becomes the specific merchant profile within the present invention. However, the present invention identifies the location-based coupon of the proximal merchant profile as the desired coupon while executing the coupon selection command, if the user account selects the location-based coupon. Then the proximal merchant profile becomes the specific merchant profile within the present invention.

In reference to FIG. 1, then the present invention sends the desired coupon, which includes a coupon description, the merchant name, the merchant address, the at least one contact number, the merchant website, and other related information, to the portable computing device. At the same time, the present invention sends and displays the promotional announcement for the specific merchant profile to the portable computing device. The promotional announcement provides additional information to the user account besides the desired coupon so that merchant account of the specific merchant profile is able to inform the user account with any upcoming deals or any other promotional information regarding the specific merchant profile.

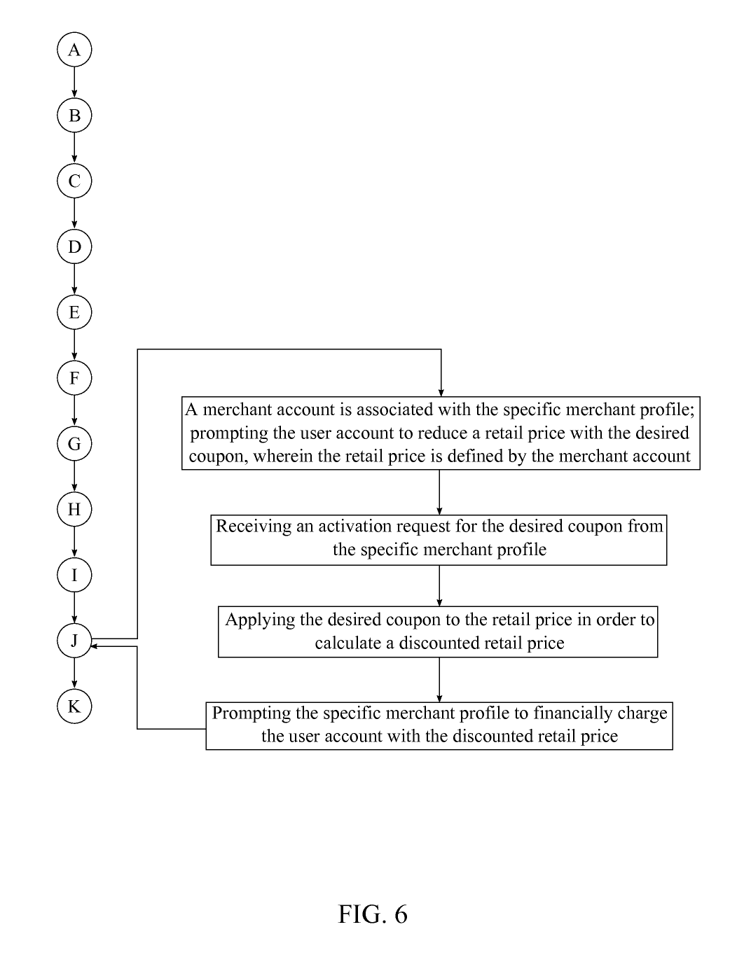

Since the user account is able to view the desired coupon through the portable computing device, the user account can redeem the desired coupon through a redeeming process of the present invention. In reference to FIG. 1 and FIG. 6, the present invention prompts the user account to reduce a retail price with the desired coupon as the retail price is defined by the merchant account. Once the user account present the desired coupon to the merchant account of the specific merchant profile, the merchant account can either scan, enter, or input the desired coupon toward the retail price. Then the present invention receives an activation request for the desired coupon from the specific merchant profile, and the present invention applies the desired coupon to the retail price in order to calculate a discounted retail price. As the final step of the redeeming process, the present invention prompts the specific merchant profile to financially charge the user account with the discounted retail price.

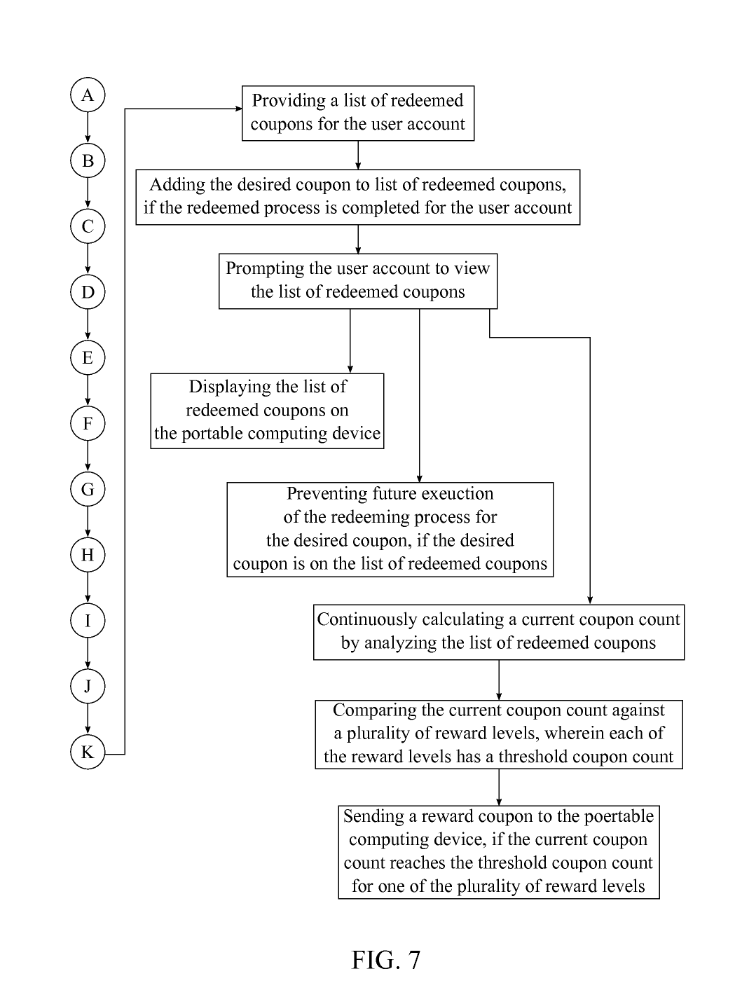

As shown in FIG. 7, once the redeeming process is completed for the user account, the present invention deactivates the desired coupon for the user account as the desired coupon is added into a list of redeemed coupons. The list of redeemed coupon is associated with the user account and displayed on the portable computing device so that the user account is able to view the list of redeemed coupons. More specifically, the list of redeemed coupons functions as a purchasing history for the user account as the list of redeemed coupons displays previous purchases of the user account. Additionally, the list of redeemed coupons prevents future execution of the redeeming process for the desired coupon. In other words, the user account is not able reuse the same desired coupon for a different product purchasing process. However, the desired coupon may be available for other user account within the specific merchant profile.

The present invention also provides a reward coupon for the user account. More specifically, the present invention continuously calculates a current coupon count by analyzing the list of redeemed coupons. Then the present invention is able to compare the current coupon count against a plurality of reward levels of the remote server as each of the plurality of reward levels has a threshold coupon count, wherein the plurality of reward levels and the threshold coupon count are pre-determined parameters stored within the remote server. If the current coupon count reaches the threshold coupon count for one of the plurality of reward levels, the present invention sends the reward coupon to the portable computing device. Then the user account is able to use the reward coupon toward any future product purchasing process.

Although the invention has been explained in relation to its preferred embodiment, it is to be understood that many other possible modifications and variations can be made without departing from the spirit and scope of the invention as hereinafter claimed.

What is claimed is:

1. A mobile coupon application network by executing computer-executable instructions stored on a non-transitory computer-readable medium, the method comprises the steps of:
providing a plurality of merchant profiles, wherein each of the plurality of merchant profiles includes a plurality of coupons, at least one promotional announcement, and a notification region;
providing a user account, wherein the user account is accessed through a portable computing device;
receiving a desired location for the user account from the portable computing device;
monitoring a synthetic region for the user account, wherein the synthetic region is a radial area currently surrounding a physical location of the portable computing device;
prompting the user account to browse through and to select from the plurality of coupons for each of the plurality of merchant profiles;
receiving a coupon selection command from the user account, wherein the coupon selection command is associated with a specific merchant profile from the plurality of merchant profiles;
executing the coupon selection command in order to identify a desired coupon for the user account;
sending the desired coupon to the portable computing device;
sending and displaying the promotional announcement for the specific merchant profile to the portable computing device;
executing a redeeming process for the desired coupon; and
deactivating the desired coupon for the user account,
if the redeeming process is completed for the user account.

2. The mobile coupon application network by executing computer-executable instructions stored on a non-transitory computer-readable medium, the method as claimed in claim 1 comprises the steps of:
receiving a merchant name, a merchant address, a merchant website, and at least one contact number from a merchant account, wherein the merchant account is associated with the specific merchant profile;
receiving a merchant definition of the notification region from the merchant account;
graphically displaying the merchant definition of the notification region on a virtual map; and
receiving the plurality of coupons and the promotional announcement from the merchant account.

3. The mobile coupon application network by executing computer-executable instructions stored on a non-transitory computer-readable medium, the method as claimed in claim 2 comprises the steps of:
prompting the merchant account to group the specific merchant profile with proximal merchant profiles from the plurality of merchant profiles, wherein the proximal merchant profiles share a physical address with the specific merchant profile; and
generating an expanded notification region for the specific merchant profile and the proximal merchant profiles, wherein the expanded notification region is a combination of the notification region for the specific merchant profile and the notification region for each of the proximal merchant profiles.

4. The mobile coupon application network by executing computer-executable instructions stored on a non-transitory computer-readable medium, the method as claimed in claim 1 comprises the steps of:
continuously and geospatially searching wireless communication networks in order to detect the desired location of the portable computing device.

5. The mobile coupon application network by executing computer-executable instructions stored on a non-transitory computer-readable medium, the method as claimed in claim 1 comprises the steps of:
prompting the user account to enter the desired location in order to receive the desired location from the portable computing device.

6. The mobile coupon application network by executing computer-executable instructions stored on a non-transitory computer-readable medium, the method as claimed in claim 1 comprises the steps of:
continuously transmitting at least one location-based coupon within the notification area for each of the plurality of merchant profiles, wherein the plurality of coupons for each of the plurality of merchant profiles includes the location-based coupon;
prompting the user account to view the location-based coupon for at least one proximal merchant profile,
if the synthetic region physically intersects with the notification area of the at least one proximal merchant profile;
displaying the location-based coupon for the at least one proximal merchant profile on the portable computing device; and
identifying the location-based coupon of the at least one proximal merchant profile as the desired coupon while executing the coupon selection command, wherein the at least one proximal merchant profile becomes the specific merchant profile.

7. The mobile coupon application network by executing computer-executable instructions stored on a non-transitory computer-readable medium, the method as claimed in claim 1 comprises the steps of:
wherein the plurality of coupons for each of the plurality of merchant profiles includes at least one non-location-based coupon;
prompting the user account to view the non-location-based coupon for at least one preferred merchant profile,
if the desired location intersects with the notification area of the preferred merchant profile;
displaying the non-location-based coupon for the preferred merchant profile on the portable computing device; and
identifying the non-location-based coupon of the preferred merchant profile as the desired coupon while executing the coupon selection command, wherein the preferred merchant profile becomes the specific merchant profile.

8. The mobile coupon application network by executing computer-executable instructions stored on a non-transitory computer-readable medium, the method as claimed in claim 1 comprises the steps of:
wherein a merchant account is associated with the specific merchant profile;
prompting the user account to reduce a retail price with the desired coupon, wherein the retail price is defined by the merchant account;
receiving an activation request for the desired coupon from the specific merchant profile;
applying the desired coupon to the retail price in order to calculate a discounted retail price; and
prompting the specific merchant profile to financially charge the user account with the discounted retail price.

9. The mobile coupon application network by executing computer-executable instructions stored on a non-transitory computer-readable medium, the method as claimed in claim 1 comprises the steps of:
providing a list of redeemed coupons for the user account;
adding the desired coupon to the list of redeemed coupons,
if the redeeming process is completed for the user account;
prompting the user account to view the list of redeemed coupons; and
displaying the list of redeemed coupons on the portable computing device.

10. The mobile coupon application network by executing computer-executable instructions stored on a non-transitory computer-readable medium, the method as claimed in claim 1 comprises the steps of:
providing a list of redeemed coupons for the user account;
adding the desired coupon to the list of redeemed coupons,
if the redeeming process is completed for the user account; and
preventing future execution of the redeeming process for the desired coupon,
if the desired coupon is on the list of redeemed coupons.

11. The mobile coupon application network by executing computer-executable instructions stored on a non-transitory computer-readable medium, the method as claimed in claim 1 comprises the steps of:
providing a list of redeemed coupons for the user account;
continuously calculating a current coupon count by analyzing the list of redeemed coupons;
comparing the current coupon count against a plurality of reward levels, wherein each of the plurality of reward levels has a threshold coupon count; and
sending a reward coupon to the portable computing device,
if the current coupon count reaches the threshold coupon count for one of the plurality of reward levels.
